(19) United States
(12) Patent Application Publication
(10) Pub. No.: US 2015/0322625 A1
(43) Pub. Date: Nov. 12, 2015

(54) PRETREATMENT METHOD FOR CELLULOSE-CONTAINING BIOMASS, PRODUCTION METHOD FOR SACCHARIFYING BIOMASS COMPOSITION, AND SUGAR PRODUCTION METHOD

(71) Applicant: SHOWA DENKO K. K., Minato-ku, Tokyo (JP)

(72) Inventors: Syoichiro WAKABAYASHI, Tokyo (JP); Ichiro FUJITA, Tokyo (JP); Shinji YAMAKI, Tokyo (JP); Tadashi YONEDA, Tokyo (JP)

(73) Assignee: SHOWA DENKO K.K., Tokyo (JP)

(21) Appl. No.: 14/651,690

(22) PCT Filed: Nov. 19, 2013
(86) PCT No.: PCT/JP2013/081180

§ 371 Date: Jun. 12, 2015

(30) Foreign Application Priority Data
Dec. 13, 2012 (JP) 2012-272431

(51) Int. Cl. D21B 1/14; C13K 1/02

(52) U.S. Cl. CPC D21B 1/14; C13K 1/02

(57) ABSTRACT

A pretreatment method (1) for improving saccharification performance of a cellulose-containing biomass as a saccharification starting material, which includes: step 1 of pulverizing cellulose-containing biomass; step 2 of subjecting the pulverized cellulose-containing biomass to hydrothermal treatment; and step 3 of finely pulverizing the cellulose-containing biomass subjected to the hydrothermal treatment. The fine pulverization in step 3 is performed by using a refiner or disc mill provided with a plate or disc without a flow passage leading from a center toward a circumferential direction. Also disclosed is (2) a method for producing a biomass composition for saccharification, which includes conducting the pretreatment method; and (3) a method for producing a sugar, which includes hydrolyzing a biomass composition for saccharification obtained by the production method.

### TECHNICAL FIELD

The present invention relates to production of a sugar through hydrolysis of cellulose-containing biomass. Particularly, the present invention relates to a pretreatment method for enhancing the saccharification performance of a cellulose-containing biomass serving as a raw material, a method for producing a biomass composition for saccharification, and to a method for producing a sugar.

### BACKGROUND ART

As part of measures against global warming, there have been wide investigations on production of various chemical products including ethanol through effective utilization of cellulose-containing biomass. Examples of the cellulose-containing biomass include hard biomass such as cedar or cypress, and soft biomass such as rice straw, wheat straw, corncobs, cassava, bagasse, or sugar cane leaves. The biomass may contain hemicellulose, lignin, and the like, and hence it is difficult to directly saccharify the biomass. Therefore, there have been proposals to enhance its saccharification performance through various pretreatments.

As classical pretreatment methods, acid treatment, alkali treatment, hydrothermal treatment, and the like have been proposed. The acid treatment is a technology capable of effectively removing hemicellulose as an impurity, but has a problem in that its industrial practice entails high cost owing to corrosion of a device due to an acid and necessity of neutralization of the used acid in a subsequent step. The alkali treatment is a technology capable of effectively removing lignin as an impurity, but has a problem in that its industrial practice entails high cost owing to a large cellulose loss and decrease in production per material unit. On the other hand, regarding the hydrothermal treatment, which involves heating the biomass together with water, there has been a proposal to enhance its pretreatment effect by combination use with physical pulverization treatment, because the hydrothermal treatment does not use a chemical such as an acid or an alkali and hence has a low treatment effect (JP 2006-136263 A; Patent Document 1). However, industrially useful treatment conditions are not explicitly disclosed.

Other than the above-mentioned methods, there have been proposed water vapor blasting, ammonia blasting, ozone oxidation, white-rot fungus treatment, microwave irradiation, electron beam irradiation, and γ-ray irradiation (Journal of The Japan Wood Research Society, 53, 1 to 13 (2007); Non Patent Document 1). However, those methods are treatment methods involving high facility cost and high chemical cost, and are insufficient for industrial practice from the viewpoint of cost-effectiveness.

### PRIOR ART

### Patent Document

[Patent Document 1] JP 2006-136263 A

### Non-Patent Document

[Non-patent Document 1] Journal of The Japan Wood Research Society, 53, 1 to 13 (2007)

### DISCLOSURE OF THE INVENTION

### Problems to be Solved by the Invention

An object of the present invention is to provide a pretreatment method for cellulose-containing biomass capable of obtaining a biomass composition for saccharification that exhibits high saccharification performance and is industrially useful, a method for producing a biomass composition for saccharification by conducting the pretreatment method, and a method for producing a sugar through hydrolysis of the biomass composition for saccharification.

### Means to Solve the Problem

As a result of diligent investigations aimed at achieving the above-mentioned object, the inventors of the present invention have found that, in pretreatment of cellulose-containing biomass, it is effective to finely pulverize the cellulose-containing biomass with a refiner or disc mill, and to use a fine pulverization device having a structure, in which a retention time period of a material to be pulverized is prolonged in a pulverization region, in order to sufficiently bring out a high saccharification effect of a finely pulverized product. Thus, the present invention has been completed.

That is, the present invention relates to the following pretreatment method for cellulose-containing biomass, a method for producing a biomass composition for saccharification, and a method for producing a sugar.

[1] A pretreatment method for cellulose-containing biomass, for enhancing saccharification performance in a hydrolysis reaction, comprising:

step 1 of pulverizing cellulose-containing biomass;

step 2 of subjecting the pulverized cellulose-containing biomass to hydrothermal treatment; and

step 3 of finely pulverizing the cellulose-containing biomass subjected to the hydrothermal treatment,

wherein the fine pulverization in step 3 is performed by using a refiner or disc mill provided with a plate or disc without a flow passage leading from a center toward a circumferential direction.

[2] The pretreatment method according to [1] above, in which the cellulose-containing biomass is soft biomass.

[3] The pretreatment method according to [1] or [2] above, in which the pulverization of the cellulose-containing biomass in step 1 is performed by using a screen of from 1 to 30 mmφ.

[4] The pretreatment method according to any one of [1] to [3] above, in which the hydrothermal treatment in step 2 includes heating a mixture of the pulverized cellulose-containing biomass obtained in step 1 and water at a temperature of from 180 to 250° C. for from 1 to 100 minutes.

[5] The pretreatment method according to any one of [1] to [4] above, in which a mass ratio between the cellulose-containing biomass in terms of dry mass and water in the hydrothermal treatment in step 2 is from 1:4 to 1:97.

[6] The pretreatment method according to any one of [1] to [5] above, in which the hydrothermal treatment is performed by using water having a pH of from 5.8 to 8.6.

[7] The pretreatment method according to any one of [1] to [6] above, in which the fine pulverization step 3 with a refiner or disc mill is performed a plurality of times.

[8] A method for producing a biomass composition for saccharification, the method comprising conducting the pretreatment method described in any one of [1] to [7] above.

[9] A method for producing a sugar, comprising hydrolyzing a biomass composition for saccharification obtained by the production method described in [8] above.

### Effects of Invention

According to the pretreatment method for cellulose-containing biomass of the present invention, the biomass composition for saccharification useful as a raw material for producing a sugar through a hydrolysis reaction is obtained. Thus, sugar can be efficiently produced from cellulose-containing biomass.

### Mode for Carrying out the Invention

A pretreatment method for cellulose-containing biomass of the present invention for enhancing its saccharification performance in a hydrolysis reaction comprises: a step of pulverizing cellulose-containing biomass (step 1); a step of subjecting the pulverized cellulose-containing biomass to hydrothermal treatment (step 2); and a step of finely pulverizing the cellulose-containing biomass subjected to hydrothermal treatment with a refiner or disc mill (step 3). In step 3, the fine pulverization is performed by using a refiner or disc mill provided with a plate or disc without a flow passage leading from a center toward a circumferential direction.

Herein, the refiner or disc mill is a device configured to continuously conduct treatment such as pulverization or beating between rotary grinding plates (plates or discs) rotating at a high speed. In general, the refiner uses a rotary grinding plate (referred to as plate) made of a metal such as stainless steel, and the disc mill uses a rotary grinding plate (referred to as disc) made of silicon carbide, alumina oxide and the like.

In the fine pulverization step 3, it is important to prolong a retention time period of a material to be pulverized and thus sufficiently bring out a saccharification effect of a finely pulverized product. For this, it is advantageous that the plate of the refiner or the disc of the disc mill to be used has a shape capable of prolonging the retention time period of the material to be pulverized.

The plate or disc generally rotates at a high speed, and hence a large force directed outward of the plate or disc is applied through a centrifugal force to the material to be pulverized which was introduced in the vicinity of the center of the plate or disc. Therefore, in the case of using a refiner or disc mill provided with a plate or disc having a flow passage leading from a center toward a circumferential direction, the material to be pulverized is discharged from the device without being sufficiently pulverized in a fine pulverization region. The “flow passage” as used herein refers to a space formed between cutting blades formed on the plate.

In contrast, in the case of using the refiner or disc mill provided with a plate or disc without a flow passage leading from a center toward a circumferential direction, the retention time period of the material to be pulverized is prolonged in the fine pulverization region, and the saccharification effect of the finely pulverized product can be sufficiently brought out. Therefore, in the present invention, the fine pulverization in the step 3 is performed by using the refiner or disc mill provided with a plate or disc without a flow passage leading from a center toward a circumferential direction.

In addition, from the viewpoint of prolonging the retention time period of the material to be pulverized in the fine pulverization region, also operation conditions have large influences. For example, in the case where the distance between the plates or the distance between the discs is small, it causes an increase in a force in a direction such that the force directed outward generated by a centrifugal force is canceled, and the retention time period is relatively prolonged in the fine pulverization region. In addition, as the number of rotations of the plate or disc becomes small, the centrifugal force to be generated becomes small in itself. Thus, the retention time period is prolonged in the fine pulverization region.

In the present invention, it is important to prolong the retention time period of the material to be pulverized in the fine pulverization region. However, a method adopting an extremely long retention time period is not preferred as an industrial production method because it reduces productivity.

The biomass in the present invention means a biopolymer (nucleic acid, protein, or polysaccharide) or an industrial resource derived from such constituent component, other than exhaustible resources (fossil fuel such as petroleum, coal, or natural gas). Therefore, examples of the cellulose-containing biomass include hard biomass such as wood, and soft biomass such as rice straw, wheat straw, corncobs, cassava, bagasse, or sugar cane leaves. Soft biomass is preferred in consideration of the ease of the pretreatment, and further, bagasse and sugar cane leaves are particularly preferred in consideration of their global storage potential and collection cost.

In the pretreatment method of the present invention, the cellulose-containing biomass is pulverized in step 1 before the hydrothermal treatment step (step 2). In the pulverization step 1, the cellulose-containing biomass is preferably pulverized by using a screen (sieve) having a screen diameter of from 1 to 30 mmφ. The screen diameter falls within a range of more preferably from 2 to 20 mmφ, most preferably from 3 to 10 mmφ. The case where the screen diameter is too large in the pulverization is not preferred because, in such case, the grain size of the cellulose-containing biomass becomes large, and hence a pretreatment effect to be obtained through subsequent steps lowers and the production cost of a sugar becomes high. In addition, the case where the screen diameter is too small in the pulverization is not preferred because, in such case, pulverization cost becomes high. In the case of pulverizing the cellulose-containing biomass without using the screen, it is preferred that the biomass be pulverized to the size corresponding to that of a pulverized product obtained by using the screen.

In the hydrothermal treatment in step 2, the pulverized cellulose-containing biomass is preferably heated at a temperature of from 180 to 250° C. in the presence of water. The heating temperature is more preferably from 190 to 240° C., most preferably from 200 to 230° C. The case where the heating temperature is too high is not preferred because, in such case, energy cost becomes rather high, and in addition, decomposition of cellulose or excessive decomposition of impurities proceeds. In addition, the case where the heating temperature is too low is not preferred because, in such case, the pretreatment effect lowers, and the production cost of the sugar becomes high. It should be noted that the hydrothermal treatment may be performed by using a sealed container such as an autoclave, but can be performed in a non-sealed state.

A heating time period in the hydrothermal treatment is preferably from 1 to 100 minutes. The heating time period is more preferably from 2 to 30 minutes, most preferably from 3 to 15 minutes. The case where the heating time period is too long is not preferred because, in such case, the productivity in the pretreatment steps lowers, and hence the production cost of the sugar becomes high. The case where the heating time period is too short is not preferred because, in such case, the pretreatment effect lowers, and hence the production cost of the sugar becomes high. It should be noted that the preferred range of the heating time period varies within the above-mentioned range depending on the heating temperature to be adopted.

The mass ratio between the cellulose-containing biomass in terms of dry mass and water in the hydrothermal treatment is preferably from 1:4 to 1:97. The mass ratio is more preferably from 1:6 to 1:20, most preferably from 1:8 to 1:13. The case where the amount of water is too large with respect to the cellulose-containing biomass in terms of dry mass is not preferred because, in such case, the scale of a pretreatment device becomes large, resulting in low economic efficiency. In addition, the case where the amount of water is too small with respect to the cellulose-containing biomass in terms of dry mass is not preferred because, in such case, the pretreatment effect lowers, and the production cost of the sugar becomes high.

In the present invention, an acid or an alkali may be added as an additive to water in the hydrothermal treatment in step 2. However, the use of an additive entails chemical cost, and cost for detoxification by neutralization or the like in a subsequent step as well. Therefore, it is preferred from an industrial viewpoint to use only water, which is generally available. In view of the foregoing, water to be used preferably has a pH of from 5.8 to 8.6. The pH is more preferably from 6.1 to 8.3, most preferably from 6.3 to 8.0.

In the present invention, it is preferred to finely pulverize the cellulose-containing biomass until a biomass composition having an average particle size of 300 μm or less is obtained, by performing the above-mentioned fine pulverization (step 3) a plurality of times after step 2 of subjecting the cellulose-containing biomass to the hydrothermal treatment. The number of times of pulverization is preferably from 4 to 50, more preferably from 6 to 30. The case where the number of times of pulverization is too small is not preferred because, in such case, the pretreatment effect lowers, and the production cost of the sugar becomes high. The case where the number of times of pulverization is too large is not preferred because, in such case, the pulverization cost becomes high.

By the pretreatment method comprising the above-mentioned steps 1 to 3, a biomass composition for saccharification exhibiting high saccharification performance in a hydrolysis reaction can be obtained.

As a method of hydrolyzing and saccharifying the obtained biomass composition for saccharification, there is given a method of hydrolyzing cellulose by using a solid acid catalyst or a mineral acid catalyst such as sulfuric acid or a method of hydrolyzing cellulose by using an enzyme. The hydrolysis method using an enzyme is industrially advantageous because impurities are generated in small amounts and the obtained sugar has a high utility value.

The hydrolysis of cellulose with an enzyme is performed by, for example, allowing a generally known cellulase to act on the biomass composition for saccharification of the present invention. While the properties of the cellulase slightly vary depending on the kind of the cellulase, an optimum pH falls within a range of from 3.5 to 5.5 and an optimum temperature falls within a range of from 35 to 55° C. Therefore, cellulose is hydrolyzed by treating the biomass composition at a temperature of from 35 to 55° C. for a predetermined time period after a buffer solution having a pH of from 3.5 to 5.5 is added thereto. Thus, the sugar can be produced.

### EXAMPLES

Hereinafter, the present invention is described by way of Example and Comparative Example. However, the present invention is not limited to the descriptions of Example and Comparative Example.

[Analysis Method for Content Rate of Cellulose]

300 mg of biomass was weighed after being dried at 105° C. for 1 hour in a 100 ml screw-cap reagent bottle. 3 ml of 72% sulfuric acid was added thereto, and the solution was well stirred with a glass rod, followed by being subjected to treatment in a constant temperature bath at 30° C. for 1 hour. During the treatment in the constant temperature bath, the solution was occasionally stirred with a glass rod. After the completion of the treatment, 84 ml of pure water was added thereto, and a screw-top lid was loosely closed. Then, the solution was subjected to treatment in a sterilization autoclave (SS-240 manufactured by Tomy Seiko Co., Ltd.) at 121° C. for 1 hour. After cooling, the treated solution was subjected to suction filtration using a nitrocellulose filter, and the mass of the filtrate was measured. Part of the filtrate was taken and neutralized with calcium carbonate, followed by being subjected to filtration using a filter. The filtrate was subjected to quantitative determination for glucose and xylose by high-performance liquid chromatography analysis.

[High-Performance Liquid Chromatography Analysis Method and Calculation Method for Content Rate of Cellulose]

A guard column (KS-G manufactured by Showa Denko K. K.) and a separation column (KS-802 manufactured by Showa Denko K. K.) were connected to each other, and the column temperature was set to 75° C. Pure water was supplied as an eluting solution at a rate of 0.5 ml/min, and a separated component was subjected to quantitative determination with a differential refractive index detector. Thus, the concentration of glucose was determined, and the content rate of cellulose was calculated based on the following equation.

[Equation 1]

Content rate of cellulose (mass %)=mass of filtrate (g)×concentration of glucose (mass %)×0.9/mass of weighed biomass (g)

(The numerical value “0.9” in the equation is a coefficient for correcting changes in molecular weight caused by hydrolysis of cellulose.)

[Measurement of Saccharification Performance with Enzyme]

Preparation of Acid Buffer Solution:

30 g of acetic acid was put in a 100-ml measuring flask, and diluted with pure water to give a 5 M acetic acid aqueous solution. 41 g of sodium acetate was put in a 100-ml measuring flask, and diluted with pure water to give a 5 M sodium acetate aqueous solution. The 5 M acetic acid aqueous solution was added to the 5 M sodium acetate aqueous solution until the pH reached 5.0 to obtain an acetic acid buffer solution.

Preparation of Enzyme Solution:

1.5 g of Meicelase (trademark, cellulase manufactured by Meiji Seika Kaisha, Ltd. (current Meiji Seika Pharma Co., Ltd.)) was dissolved in 98.5 g of pure water.

Saccharification Reaction:

A rotor was put in a 50-ml glass vessel with a cover, and a composition subjected to pretreatment was weighed so as to contain 0.5 g of cellulose and was put in the vessel. Then, 0.6 g of the acetic acid buffer solution and 1.03 g of the enzyme solution were added thereto, and further pure water was added thereto to give a total of 10 g. The resultant was subjected to a saccharification reaction with the enzyme in a constant temperature bath at 40° C. for 24 hours while being stirred. The resultant saccharified solution was subjected to quantitative determination for glucose by high-performance liquid chromatography analysis. Thus, a saccharification rate was determined.

### Example 1

Sugar cane leaves were pulverized with a cutter mill (MKCM-3, 3 mmφ screen, manufactured by Masuko Sangyo Co., Ltd.). After the pulverization, the sugar cane leaves had a water content of 10.4 mass %. 447 g of the sugar cane leaves were put in a 10-1 autoclave (desktop reactor OML-10 manufactured by Om Lab-Tech Co., Ltd.). Further, 3,953 g of pure water was put therein, and the autoclave was sealed. A temperature controlling gauge for liquid temperature was set to 200° C., and heating was started while stirring the content fluid at 500 rpm. Heating was continued for 10 minutes after the liquid temperature reached 190° C. After that, the heating was stopped and the resultant content was cooled.

The resultant slurry was subjected to centrifugal filtration with a centrifugal filtration device (H-122, cotton filter cloth, manufactured by Kokusan Co., Ltd.) at 3,000 rpm, to obtain a water-containing solid content. Water was added thereto so as to adjust the concentration of the solid content to 5 mass %, and the resultant was wet pulverized three times with a refiner (manufactured by Kumagai Riki Kogyo Co., Ltd., with plate A: a plate having a shape in which a plurality of cutting blades radially extending from the center of the plate toward an outer circumferential direction are formed and flow passages formed between the cutting blades are blocked by a circular cutting blade provided at the outermost circumferential portion of the plate) at a clearance of 0.02 mm. The resultant slurry was subjected to centrifugal filtration with a centrifugal filtration device at 3,000 rpm, to obtain a water-containing solid content.

The obtained water-containing solid content was evaluated for a saccharification rate by the above-mentioned method. As a result, the saccharification rate was 40% after 24 hours.

### Comparative Example 1

Sugar cane leaves were pulverized with a cutter mill. After the pulverization, the sugar cane leaves had a water content of 10.4 mass %. 447 g of the sugar cane leaves were put in a 10-1 autoclave. Further, 3,953 g of pure water was put therein, and the autoclave was sealed. A temperature controlling gauge for liquid temperature was set to 200° C., and heating was started while stirring the content fluid at 500 rpm. Heating was continued for 10 minutes after the liquid temperature reached 190° C. After that, the heating was stopped and the resultant content was cooled.

The resultant slurry was subjected to centrifugal filtration with a centrifugal filtration device at 3,000 rpm, to obtain a water-containing solid content. Water was added thereto so as to adjust the concentration of the solid content to 5 mass %, and the resultant was wet pulverized three times with a refiner (manufactured by Kumagai Riki Kogyo Co., Ltd., with plate D: a plate having a shape in which a plurality of cutting blades radially extending from the center of the plate toward an outer circumferential direction are formed and flow passages formed between the cutting blades penetrate from the center of the plate to its outermost circumferential portion) at a clearance of 0.02 mm. The resultant slurry was subjected to centrifugal filtration with a centrifugal filtration device at 3,000 rpm, to obtain a water-containing solid content.

The obtained water-containing solid content was evaluated for a saccharification rate by the above-mentioned method. As a result, the saccharification rate was 32% after 24 hours.

1. A pretreatment method for cellulose-containing biomass, for enhancing saccharification performance in a hydrolysis reaction, comprising:
step 1 of pulverizing cellulose-containing biomass;
step 2 of subjecting the pulverized cellulose-containing biomass to hydrothermal treatment; and
step 3 of finely pulverizing the cellulose-containing biomass subjected to the hydrothermal treatment,
wherein the fine pulverization in step 3 is performed by using a refiner or disc mill provided with a plate or disc without a flow passage leading from a center toward a circumferential direction.

2. The pretreatment method according to claim 1, in which the cellulose-containing biomass is soft biomass.

3. The pretreatment method according to claim 1, in which the pulverization of the cellulose-containing biomass in step 1 is performed by using a screen of from 1 to 30 mmφ.

4. The pretreatment method according to claim 1, in which the hydrothermal treatment in step 2 includes heating a mixture of the pulverized cellulose-containing biomass obtained in step 1 and water at a temperature of from 180 to 250° C. for from 1 to 100 minutes.

5. The pretreatment method according to claim 1, in which a mass ratio between the cellulose-containing biomass in terms of dry mass and water in the hydrothermal treatment in step 2 is from 1:4 to 1:97.

6. The pretreatment method according to claim 1, in which the hydrothermal treatment is performed by using water having a pH of from 5.8 to 8.6.

7. The pretreatment method according to claim 1, in which the fine pulverization with a refiner or disc mill in step 3 is performed a plurality of times.

8. A method for producing a biomass composition for saccharification, the method comprising conducting the pretreatment method claimed in claim 1.

9. A method for producing a sugar, comprising hydrolyzing a biomass composition for saccharification obtained by the production method claimed in claim 8.
